(19) United States
(12) Patent Application Publication
(10) Pub. No.: US 2017/0015433 A1
(43) Pub. Date: Jan. 19, 2017

(54) PROTECTION SYSTEM FOR POLYMERIC AIR SEPARATION MEMBRANE

(71) Applicant: Hamilton Sundstrand Corporation, Windsor Locks, CT (US)

(72) Inventor: Catherine Thibaud, South Windsor, CT (US)

(21) Appl. No.: 14/799,145

(22) Filed: Jul. 14, 2015

(51) Int. Cl. B64D 37/32; B01D 53/86; B01D 53/22; B01D 46/00; B64D 37/02; B01D 53/04

(52) U.S. Cl. CPC B64D 37/32; B64D 37/02; B01D 53/04; B01D 53/229; B01D 46/0036; B01D 53/8675; B01D 2053/221; B01D 2253/102; B01D 2253/204; B01D 2256/10; B01D 2257/104; B01D 2257/106; B01D 2259/4575

(57) ABSTRACT

An air separation system includes a feed air line for transporting feed air and an air separation module with a polymeric membrane. The air separation module is configured to receive feed air through the feed air line and separate the feed air into nitrogen-enriched air and oxygen-enriched air. The air separation system further includes a gaseous contaminant removal system upstream of the air separation module and configured to remove gaseous contaminants from the feed air received by the air separation module, and a nitrogen-enriched air line for transporting the nitrogen-enriched air from the air separation module to a fuel tank for inerting.

### BACKGROUND

This disclosure relates to air separation systems for aircraft, and more specifically to a polymeric air separation membrane in a nitrogen generation system.

Aircraft fuel tanks and containers can contain potentially combustible combinations of oxygen, fuel vapors, and ignition sources. In order to prevent combustion, the ullage of fuel tanks and containers is filled with air with high nitrogen concentration, or nitrogen-enriched air (NEA). A nitrogen generation system (NGS) is commonly used to produce NEA for inerting fuel tanks and containers. An air separation module (ASM) in the NGS separates ambient air into NEA, which is directed to fuel tanks and containers, and oxygen-enriched air (OEA), which is rejected overboard. The ASM typically includes a polymeric membrane for separating ambient air into NEA and OEA.

Polymeric membranes are sensitive to degradation either from adsorption of gaseous chemical species on or within the polymeric matrix of the membrane or from chemical reactions within the polymeric matrix. Gaseous contaminants that cause membrane degradation can be found in aerosol or gas phases in the feed stream for an NGS. These contaminants can include hydrocarbons from hydraulic fluid and deicing fluids, such as formaldehyde. Other contaminants include inorganic contaminants found in ambient air such as sulfur dioxide, nitrogen dioxide, and hydrogen sulfide. These gaseous contaminants can significantly reduce the life of the polymeric membrane in an ASM.

### SUMMARY

In one embodiment, an air separation system includes a feed air line for transporting feed air and an air separation module with a polymeric membrane. The air separation module is configured to receive feed air through the feed air line and separate the feed air into nitrogen-enriched air and oxygen-enriched air. The air separation system further includes a gaseous contaminant removal system upstream of the air separation module and configured to remove gaseous contaminants from the feed air received by the air separation module, and a nitrogen-enriched air line for transporting the nitrogen-enriched air from the air separation module to a fuel tank for inerting.

In another embodiment, an air separation system includes a feed air line for transporting feed air and an air separation module with an inlet header, a polymeric membrane, and an outlet header. The air separation module is configured to receive feed air through the feed air line and separate the feed air into nitrogen-enriched air and oxygen-enriched air. The air separation system further includes a gaseous contaminant removal system located in the inlet header of the air separation module and configured to remove gaseous contaminants from the feed air received by the air separation module, and a nitrogen-enriched air line for transporting the nitrogen-enriched air from the air separation module to a fuel tank for inerting.

In another embodiment, a method of protecting a polymeric membrane of an air separation module in an air separation system includes flowing feed air through a feed air line, removing gaseous contaminants in the feed air with a gaseous contaminant removal system, flowing the feed air through the polymeric membrane of the air separation module, separating the feed air into nitrogen-enriched air and oxygen-enriched air with the polymeric membrane, and transporting the nitrogen-enriched air from the air separation module to a fuel tank for inerting.

### BRIEF DESCRIPTION OF THE DRAWINGS

FIG. 1 is a schematic diagram of a nitrogen generation system.

FIG. 2 is a schematic diagram of another embodiment of the nitrogen generation system of FIG. 1.

FIG. 3 is a schematic diagram of another embodiment of the nitrogen generation system of FIG. 1.

### DETAILED DESCRIPTION

The present disclosure relates to an air separation system, specifically a nitrogen generation system (NGS), for generating air with high nitrogen concentration (nitrogen-enriched air). An air separation module (ASM) in the NGS separates feed air into nitrogen-enriched air (NEA) and oxygen-enriched air (OEA). The ASM includes a polymeric membrane, which separates the feed air into NEA and OEA. A gaseous contaminant removal system removes gaseous inorganic and organic contaminants from the feed air before the feed air comes into contact with the polymeric membrane in order to prevent the polymeric membrane from degrading due to exposure to the contaminants. This prolongs the life of the polymeric membrane, resulting in less frequent replacement of the membrane and lower maintenance costs for the NGS.

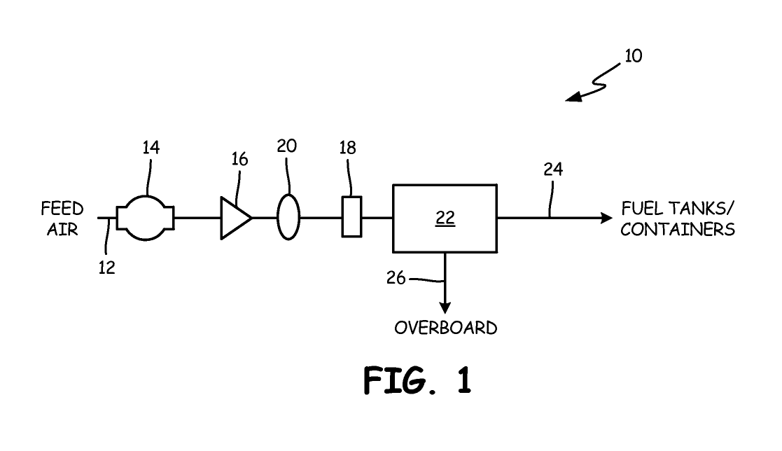

FIG. 1 is a schematic diagram of NGS 10. NGS 10 includes feed air line 12, mechanical separator 14, ozone converter 16, high-efficiency particulate arrestance (HEPA) filter 18, gaseous contaminant removal system 20, ASM 22, NEA line 24, and OEA line 26. Feed air enters NGS 10 through feed air line 12. The feed air flows through mechanical separator 14, ozone converter 16, gaseous contaminant removal system 20, and HEPA filter 18 prior to flowing into ASM 22.

ASM 22 receives feed air through feed air line 12 and separates the feed air into NEA and OEA. The NEA leaves ASM 22 through NEA line 24 and is routed to fuel tanks and containers for inerting. The OEA leaves ASM 22 through OEA line 26 and is typically rejected overboard. ASM 22 can be a membrane-based ASM with a membrane made of a polymer such as poly(1-trimethylsilyl-1-propyne), Teflon, silicone rubber, poly(4-methyl-1-pentene), poly(phenylene oxide), ethyl cellulose, polyimide, polysulfone, polyaramide, tetrabromo bis polycarbonate, or combinations thereof.

Mechanical separator 14 removes oil particles from the feed air in feed air line 12, reducing the risk of system failure due to ingestion of an oil slug. Ozone converter 16 removes ozone contaminants from the feed air using an ozone catalyst. HEPA filter 18 removes particle contaminants from the feed air. In the embodiment shown, mechanical separator 14 is located upstream of ozone converter 16, and ozone converter 16 is located upstream of HEPA filter 18.

Gaseous contaminant removal system 20 removes gaseous contaminants from the feed air in feed air line 12. These contaminants can include hydrocarbons from hydraulic fluid and deicing fluids, and engine generated contaminants such as benzene, xylenes, toluene, and formaldehyde. Other potential contaminants include inorganic contaminants found in the ground atmosphere, such as sulfur dioxide, nitrogen dioxide, and hydrogen sulfide. Gaseous contaminant removal system 20 is an adsorption and reaction system that decreases the concentration of gaseous contaminants in the feed air entering ASM 22. Gaseous contaminant removal system 20 can include a sorbent for adsorbing contaminants and a catalyst for reacting with contaminants in order to remove the contaminants from the feed air. Gaseous contaminant removal system 20 can include sorbents such as metal organic framework (MOF) sorbents or activated carbon based sorbents. MOF porous sorbents such as UiO-66 can be used to adsorb inorganic compounds such as sulfur dioxide, nitrogen dioxide, and hydrogen sulfide. Other MOF sorbents or activated carbon based sorbents can be used to adsorb hydrocarbons. Catalysts such as gold based catalysts can react with contaminants such as formaldehyde to remove them from the feed air.

In the embodiment shown, gaseous contaminant removal system 20 is placed in a flow through configuration in feed air line 12, so that the feed air flows through gaseous contaminant removal system 20. As the feed air flows through gaseous contaminant removal system 20, gaseous contaminant removal system 20 adsorbs and reacts with gaseous contaminants in the feed air, preventing the contaminants from entering ASM 22. In one embodiment, gaseous contaminant removal system 20 can include a packed bed with sorbent and catalyst pellets. In another embodiment, gaseous contaminant removal system 20 can include a filter with sorbent and catalyst fibers. It is advantageous to locate the catalyst fibers or pellets of gaseous contaminant removal system 20 in the hottest portion of gaseous contaminant removal system 20, as high temperatures are beneficial for catalytic processes. In the embodiment shown, gaseous contaminant removal system 20 is located upstream of HEPA filter 18 and downstream of ozone converter 16. In an alternative embodiment, gaseous contaminant removal system 20 can be integral to ozone converter 16 or HEPA filter 18.

Gaseous contaminant removal system 20 is advantageous, because gaseous contaminant system 20 prevents gaseous contaminants from entering ASM 22 and coming into contact with the membrane of ASM 22. This prevents degradation of the membrane of ASM 22 and improves the stability, accuracy, performance, and life of ASM 22. This results in less frequent replacement of the membrane of ASM 22 and therefore less frequent maintenance and lower maintenance costs for NGS 10.

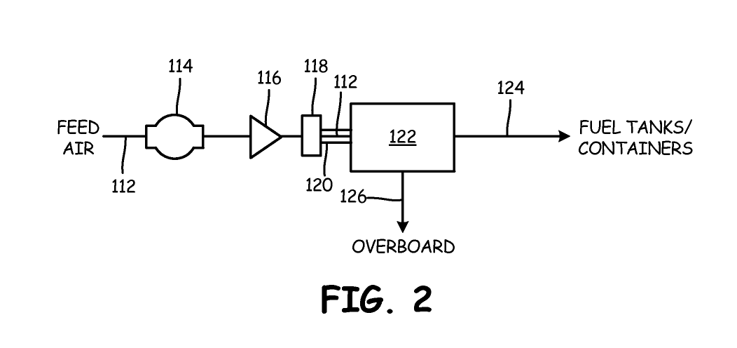

FIG. 2 is a schematic diagram of NGS 100, another embodiment of NGS 10 of FIG. 1. NGS 10 includes feed air line 112, mechanical separator 114, ozone converter 116, high-efficiency particulate arrestance (HEPA) filter 118, gaseous contaminant removal system 120, ASM 122, NEA line 124, and OEA line 126. NGS 100 functions similarly to NGS 10 in FIG. 1. Feed air enters NGS 100 through feed air line 112. The feed air flows through mechanical separator 114, ozone converter 116, HEPA filter 118, and gaseous contaminant removal system 120 prior to flowing into ASM 122.

ASM 122 receives feed air through feed air line 112 and separates the feed air into NEA and OEA. The NEA leaves ASM 122 through NEA line 124 and is routed to fuel tanks and containers for inerting. The OEA leaves ASM 122 through OEA line 126 and is typically rejected overboard. Mechanical separator 114 removes oil particles from the feed air in feed air line 112. Ozone converter 116 removes ozone contaminants from the feed air using an ozone catalyst. HEPA filter 118 removes particle contaminants from the feed air. In the embodiment shown, mechanical separator 114 is located upstream of ozone converter 116, and ozone converter 116 is located upstream of HEPA filter 118. In an alternative embodiment, HEPA filter 118 can be located upstream of ozone converter 116 and downstream of mechanical separator 114.

Gaseous contaminant removal system 120 removes gaseous contaminants from the feed air in feed air line 112. Gaseous contaminant removal system 120 functions similarly to gaseous contaminant removal system 20 of NGS 10, except gaseous contaminant removal system 120 is placed in a flow by configuration in feed air line 112. In the embodiment shown, gaseous contaminant removal system 120 is a coating that covers a portion of feed air line 112. The coating can include a sorbent for adsorbing contaminants and a catalyst for reacting with contaminants in order to remove the contaminants from the feed air entering ASM 122. When feed air flows through the portion of feed air line 112, the feed air flows by the coating of gaseous contaminant removal system 120. Gaseous contaminant removal system 120 adsorbs and reacts with gaseous contaminants in the feed air, preventing the contaminants from entering ASM 122.

Like gaseous contaminant removal system 20, gaseous contaminant removal system 120 is advantageous, because gaseous contaminant system 120 prevents gaseous contaminants from entering ASM 122 and coming into contact with the membrane of ASM 122. This prevents degradation of the membrane of ASM 122 and improves the stability, accuracy, performance, and life of ASM 122. This results in less frequent replacement of the membrane of ASM 122 and therefore less frequent maintenance and lower maintenance costs for NGS 100.

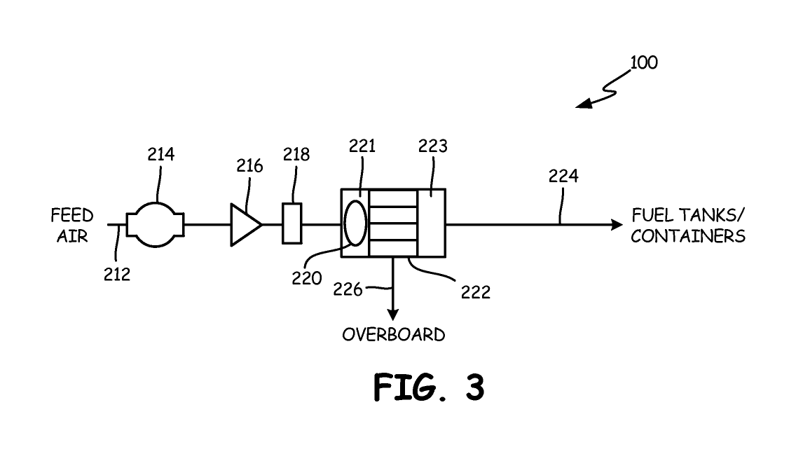

FIG. 3 is a schematic diagram of NGS 200, another embodiment of NGS 10 of FIG. 1. NGS 200 includes feed air line 212, mechanical separator 214, ozone converter 216, high-efficiency particulate arrestance (HEPA) filter 218, gaseous contaminant removal system 220, ASM 222 with inlet header 221 and outlet header 223, NEA line 224, and OEA line 226. NGS 200 functions similarly to NGS 10 in FIG. 1. Feed air enters NGS 200 through feed air line 212. The feed air flows through mechanical separator 214, ozone converter 216, and HEPA filter 218 prior to flowing into ASM 222.

ASM 222 receives feed air through feed air line 212 and separates the feed air into NEA and OEA. The NEA leaves ASM 122 through NEA line 224 and is routed to fuel tanks and containers for inerting. The OEA leaves ASM 222 through OEA line 226 and is typically rejected overboard. When feed air enters ASM 222, the feed air passes through inlet header 221 and enters the membrane of ASM 222. Gaseous contaminant removal system 220 is located in inlet header 221. Inlet header 221 is an empty space within ASM 222 where the flow of feed air is distributed prior to entering the membrane of ASM 222. The membrane separates the feed air into NEA and OEA, and the NEA flows through outlet header 223 into NEA line 224. Outlet header 223 is an empty space within ASM 222 where the NEA that is separated in the membrane of ASM 222 is combined prior to distribution to fuel tanks and containers through NEA line 224.

Mechanical separator 214 removes oil particles from the feed air in feed air line 112. Ozone converter 216 removes ozone contaminants from the feed air using an ozone catalyst. HEPA filter 218 removes particle contaminants from the feed air. In the embodiment shown, mechanical separator 214 is located upstream of ozone converter 216, and ozone converter 216 is located upstream of HEPA filter 218. In an alternative embodiment, HEPA filter 218 can be located upstream of ozone converter 216 and downstream of mechanical separator 214.

Gaseous contaminant removal system 220 removes gaseous contaminants from the feed air entering ASM 222. Gaseous contaminant removal system 220 functions similarly to gaseous contaminant removal system 20 of NGS 10, except gaseous contaminant removal system 220 is placed in a flow through configuration in inlet header 221 of ASM 222 instead of in feed air line 212. As the feed air flows through gaseous contaminant removal system 220, gaseous contaminant removal system 220 adsorbs and reacts with gaseous contaminants in the feed air, preventing the contaminants from entering the membrane of ASM 222. In one embodiment, gaseous contaminant removal system 220 can include a packed bed with sorbent and catalyst pellets. In another embodiment, gaseous contaminant removal system 220 can include a filter with sorbent and catalyst fibers.

Like gaseous contaminant removal systems 20 and 120, gaseous contaminant removal system 220 is advantageous, because gaseous contaminant system 220 prevents gaseous contaminants from entering ASM 222 and coming into contact with the membrane of ASM 222. This prevents degradation of the membrane of ASM 222 and improves the stability, accuracy, performance, and life of ASM 222. This results in less frequent replacement of the membrane of ASM 222 and therefore less frequent maintenance and lower maintenance costs for NGS 200. Gaseous contaminant removal system 220 is also advantageous, because placing gaseous contaminant removal system 220 in header 221 of ASM 222 saves space within NGS 200, allowing NGS 200 to be more compact and take up less space within an aircraft.

### Discussion of Possible Embodiments

The following are non-exclusive descriptions of possible embodiments of the present invention.

An air separation system according to an exemplary embodiment of this disclosure, among other possible things includes a feed air line for transporting feed air and an air separation module with a polymeric membrane. The air separation module is configured to receive feed air through the feed air line and separate the feed air into nitrogen-enriched air and oxygen-enriched air. The air separation system further includes a gaseous contaminant removal system upstream of the air separation module and configured to remove gaseous contaminants from the feed air received by the air separation module, and a nitrogen-enriched air line for transporting the nitrogen-enriched air from the air separation module to a fuel tank for inerting.

The air separation system of the preceding paragraph can optionally include, additionally and/or alternatively, any one or more of the following features, configurations and/or additional components:

A further embodiment of the foregoing air separation system, wherein the gaseous contaminant removal system includes a sorbent and a catalyst.

A further embodiment of any of the foregoing air separation systems, wherein the gaseous contaminant removal system includes a packed bed with sorbent and catalyst pellets or a filter with sorbent and catalyst fibers.

A further embodiment of any of the foregoing air separation systems, wherein the sorbent is selected from the group consisting of a metal organic framework porous sorbent, an activated carbon based sorbent, and combinations thereof, and wherein the catalyst is gold based.

A further embodiment of any of the foregoing air separation systems, wherein the sorbent and the catalyst coat a portion of the feed air line.

A further embodiment of any of the foregoing air separation systems, and further including a high-efficiency particulate arrestance filter upstream of the air separation module.

A further embodiment of any of the foregoing air separation systems, and further including an ozone converter upstream of the high-efficiency particulate arrestance filter.

A further embodiment of any of the foregoing air separation systems, and further including a mechanical separator upstream of the ozone converter.

An air separation system according to an exemplary embodiment of this disclosure, among other possible things includes a feed air line for transporting feed air and an air separation module with an inlet header, a polymeric membrane, and an outlet header. The air separation module is configured to receive feed air through the feed air line and separate the feed air into nitrogen-enriched air and oxygen-enriched air. The air separation system further includes a gaseous contaminant removal system located in the inlet header of the air separation module and configured to remove gaseous contaminants from the feed air received by the air separation module, and a nitrogen-enriched air line for transporting the nitrogen-enriched air from the air separation module to a fuel tank for inerting.

The air separation system of the preceding paragraph can optionally include, additionally and/or alternatively, any one or more of the following features, configurations and/or additional components:

A further embodiment of the foregoing air separation system, wherein the gaseous contaminant removal system includes a sorbent and a catalyst.

A further embodiment of any of the foregoing air separation systems, wherein the gaseous contaminant removal system includes a packed bed with sorbent and catalyst pellets or a filter with sorbent and catalyst fibers.

A further embodiment of any of the foregoing air separation systems, wherein the sorbent is selected from the group consisting of a metal organic framework porous sorbent, an activated carbon based sorbent, and combinations thereof, and wherein the catalyst is gold based.

A further embodiment of any of the foregoing air separation systems, and further including a high-efficiency particulate arrestance filter upstream of the gaseous contaminant removal system.

A further embodiment of any of the foregoing air separation systems, and further including an ozone converter upstream of the high-efficiency particulate arrestance filter.

A further embodiment of any of the foregoing air separation systems, and further including a mechanical separator upstream of the ozone converter.

A method of protecting a polymeric membrane of an air separation module in an air separation system according to an exemplary embodiment of this disclosure, among other possible things includes flowing feed air through a feed air line, removing gaseous contaminants in the feed air with a gaseous contaminant removal system, flowing the feed air through the polymeric membrane of the air separation module, separating the feed air into nitrogen-enriched air and oxygen-enriched air with the polymeric membrane, and transporting the nitrogen-enriched air from the air separation module to a fuel tank for inerting.

The method of the preceding paragraph can optionally include, additionally and/or alternatively, any one or more of the following features, configurations and/or additional components:

A further embodiment of the foregoing method, wherein removing gaseous contaminants in the feed air comprises flowing the feed air through or by a sorbent and a catalyst.

A further embodiment of any of the foregoing methods, wherein the sorbent is selected from the group consisting of a metal organic framework porous sorbent, an activated carbon based sorbent, and combinations thereof and wherein the catalyst is gold based.

A further embodiment of any of the foregoing methods, wherein the gaseous contaminants in the feed air are removed in a header of the air separation module.

A further embodiment of any of the foregoing methods, and further including removing oil particles from the feed air with a mechanical separator, removing ozone contaminants from the feed air with an ozone converter, and filtering the feed air with a high-efficiency particulate arrestance filter.

While the invention has been described with reference to an exemplary embodiment(s), it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment(s) disclosed, but that the invention will include all embodiments falling within the scope of the appended claims.

1. An air separation system comprising:
a feed air line for transporting feed air;
an air separation module with a polymeric membrane, the air separation module configured to receive feed air through the feed air line and separate the feed air into nitrogen-enriched air and oxygen-enriched air;
a gaseous contaminant removal system upstream of the air separation module and configured to remove gaseous contaminants from the feed air received by the air separation module;
a nitrogen-enriched air line for transporting the nitrogen-enriched air from the air separation module to a fuel tank for inerting.

2. The air separation system of claim 1, wherein the gaseous contaminant removal system includes a sorbent and a catalyst.

3. The air separation system of claim 2, wherein the gaseous contaminant removal system includes a packed bed with sorbent and catalyst pellets or a filter with sorbent and catalyst fibers.

4. The air separation system of claim 2, wherein the sorbent is selected from the group consisting of a metal organic framework porous sorbent, an activated carbon based sorbent, and combinations thereof; and wherein the catalyst is gold based.

5. The air separation system of claim 2, wherein the sorbent and the catalyst coat a portion of the feed air line.

6. The air separation system of claim 1, and further comprising a high-efficiency particulate arrestance filter upstream of the air separation module.

7. The air separation system of claim 6, and further comprising an ozone converter upstream of the high-efficiency particulate arrestance filter.

8. The air separation system of claim 7, and further comprising a mechanical separator upstream of the ozone converter.

9. An air separation system comprising:
a feed air line for transporting feed air;
an air separation module with an inlet header, a polymeric membrane, and an outlet header, the air separation module configured to receive feed air through the feed air line and separate the feed air into nitrogen-enriched air and oxygen-enriched air;
a gaseous contaminant removal system located in the inlet header of the air separation module and configured to remove gaseous contaminants from the feed air received by the air separation module;
a nitrogen-enriched air line for transporting the nitrogen-enriched air from the air separation module to a fuel tank for inerting.

10. The air separation system of claim 9, wherein the gaseous contaminant removal system includes a sorbent and a catalyst.

11. The air separation system of claim 10, wherein the gaseous contaminant removal system includes a packed bed with sorbent and catalyst pellets or a filter with sorbent and catalyst fibers.

12. The air separation system of claim 10, wherein the sorbent is selected from the group consisting of a metal organic framework porous sorbent, an activated carbon based sorbent, and combinations thereof; and wherein the catalyst is gold based.

13. The air separation system of claim 9, and further comprising a high-efficiency particulate arrestance filter upstream of the air separation module.

14. The air separation system of claim 13, and further comprising an ozone converter upstream of the high-efficiency particulate arrestance filter.

15. The air separation system of claim 14, and further comprising a mechanical separator upstream of the ozone converter.

16. A method of protecting a polymeric membrane of an air separation module in an air separation system, the method comprising:
flowing feed air through a feed air line;
removing gaseous contaminants in the feed air with a gaseous contaminant removal system;
flowing the feed air through the polymeric membrane of the air separation module;
separating the feed air into nitrogen-enriched air and oxygen-enriched air with the polymeric membrane; and
transporting the nitrogen-enriched air from the air separation module to a fuel tank for inerting.

17. The method of claim 16, wherein removing gaseous contaminants in the feed air comprises flowing the feed air through or by a sorbent and a catalyst.

18. The method of claim 17, wherein the sorbent is selected from the group consisting of a metal organic framework porous sorbent, an activated carbon based sorbent, and combinations thereof and wherein the catalyst is gold based.

19. The method of claim 16, wherein the gaseous contaminants in the feed air are removed in a header of the air separation module.

20. The method of claim 16, and further comprising:
removing oil particles from the feed air with a mechanical separator;
removing ozone contaminants from the feed air with an ozone converter; and
filtering the feed air with a high-efficiency particulate arrestance filter.
